(19) United States
(12) Patent Application Publication
(10) Pub. No.: US 2023/0242561 A1
(43) Pub. Date: Aug. 3, 2023

(54) NOBLE METAL COMPLEXES COMPRISING DIOLEFIN AND C6-C18 MONOCARBOXYLATE LIGANDS FOR SURFACE COATING

(71) Applicant: Heraeus Deutschland GmbH & Co. KG, HANAU (DE)

(72) Inventors: Robert SIEVI, Hanau (DE); Michael GOCK, Hanau (DE); Richard WALTER, Hanau (DE)

(21) Appl. No.: 18/002,590

(22) PCT Filed: Jul. 8, 2020
(86) PCT No.: PCT/EP2020/069185

§ 371 Date: Dec. 20, 2022

(30) Foreign Application Priority Data
Jun. 25, 2020 (EP) 20182155.0

(51) Int. Cl. C07F 15/00; C23C 18/08

(52) U.S. Cl. CPC C07F 15/006; C07F 15/0033; C07F 15/0046; C23C 18/08

(57) ABSTRACT

The invention relates to a noble metal complex comprising diolefin and C6-C18 monocarboxylate ligands of the type [LPd[O(CO)R1]X]ₙ, [LRh[O(CO)R1]]ₘ or [LIr[O(CO)R1]]ₘ, in which L represents a compound acting as a diolefin ligand, wherein X is selected from bromide, chloride, iodide and —O(CO)R2, wherein —O(CO)R1 and —O(CO)R2 represent identical or different non-aromatic C6-C18 monocarboxylic acid residues, in each case with the exception of a phenylacetic acid residue, and wherein n is an integer ≥1 and m is an integer ≥2.

The present invention relates to novel noble metal complexes, to methods for the production thereof, and to the use thereof for producing layers comprising noble metal.

WO90/07561 A1 discloses noble metal complexes of the formula LM[O(CO)R]₂, wherein L represents a nitrogen-free cyclic polyolefin ligand, preferably cyclooctadiene (COD) or pentamethylcyclopentadiene, and M represents platinum or iridium, and wherein R denotes benzyl, aryl, or alkyl having four or more carbon atoms, particularly preferably phenyl.

The object of the present invention was to find noble metal compounds which can be used to produce layers comprising noble metal, in particular even on temperature-sensitive substrates.

This object can be achieved by providing noble metal complexes of palladium, rhodium or iridium, in each case having diolefin and C6-C18 monocarboxylate ligands. More specifically, noble metal complexes of the type [LPd[O(CO)R1]X]ₙ or of the type [LM[O(CO)R1]]ₘ are provided, wherein L denotes a compound acting as a diolefin ligand, wherein M is selected from rhodium and iridium, wherein X is selected from bromide, chloride, iodide and —O(CO)R2, wherein —O(CO)R1 and —O(CO)R2 denote identical or different non-aromatic C6-C18 monocarboxylic acid residues, in each case with the exception of a phenylacetic acid residue, and wherein n is an integer ≥1 and m is an integer ≥2. In other words, according to the invention, noble metal complexes having diolefin and C6-C18 monocarboxylate ligands of the type [LPd[O(CO)R1]X]ₙ, [LRh[O(CO)R1]]ₘ or [LIr[O(CO)R1]]ₘ are provided, wherein L denotes a compound acting as a diolefin ligand, wherein X is selected from bromide, chloride, iodide and —O(CO)R2, wherein —O(CO)R1 and —O(CO)R2 denote identical or different non-aromatic C6-C18 monocarboxylic acid residues, in each case with the exception of a phenylacetic acid residue, and wherein n is an integer ≥1 and m is an integer ≥2.

The term “compound acting as a diolefin ligand” used herein refers to a compound which, in the noble metal complexes according to the invention, provides both of, or two of, its olefinic double bonds with a central noble metal atom to form a complex or with two central noble metal atoms in a bridging manner to form a complex.

In the case of polynuclear noble metal complexes according to the invention, the numbers n and m generally denote an integer, for example in the range from 2 to 5. In other words, here, integer n>1 is generally in the range from 2 to 5; in particular, n is in this case 2 and the noble metal complexes according to the invention are then dinuclear palladium complexes. Integer m is also generally in the range from 2 to 5 here; in particular, m is in this case 2 and the noble metal complexes according to the invention are then dinuclear rhodium or iridium complexes.

In the embodiment of mononuclear palladium complexes according to the invention of the type [LPd[O(CO)R1]X], L is a compound acting as a diolefin ligand at the central palladium atom; X denotes bromide, chloride, iodide, or —O(CO)R2; and —O(CO)R1 and —O(CO)R2 denote identical or different non-aromatic C6-C18 monocarboxylic acid residues, in each case with the exception of a phenylacetic acid residue. In this case, n is 1.

In a preferred embodiment of dinuclear or polynuclear palladium complexes according to the invention of the type [LPd[O(CO)R1]X]ₙ, L denotes a compound acting as a diolefin ligand; X denotes bromide, chloride, iodide or —O(CO)R2; n denotes 2, 3, 4 or 5, preferably 2; and —O(CO)R1 and —O(CO)R2 denote identical or different non-aromatic C6-C18 monocarboxylic acid residues, in each case with the exception of a phenylacetic acid residue.

In a preferred embodiment of dinuclear or polynuclear noble metal complexes according to the invention of the type [LM[O(CO)R1]]ₘ, L denotes a compound acting as a diolefin ligand; M denotes rhodium or iridium, m denotes 2, 3, 4, or 5, preferably 2; and —O(CO)R1 denotes a non-aromatic C6-C18 monocarboxylic acid residue with the exception of a phenylacetic acid residue.

The invention relates to said noble metal complexes in individualized and also in combined form, i.e., alone or also as a mixture of a plurality of different species. Thus, the invention can relate to palladium complexes in individualized or combined form, i.e., alone or as a mixture of a plurality of different species, in each case of the type [LPd[O(CO)R1]X]ₙ. The invention can also relate to rhodium complexes in individualized or combined form, i.e., alone or as a mixture of a plurality of different species, in each case of the type [LRh[O(CO)R1]]ₘ. Further, the invention can relate to iridium complexes in individualized or combined form, i.e., alone or as a mixture of a plurality of different species, in each case of the type [LIr[O(CO)R1]]ₘ.

Examples of diolefins or compounds of the type L that are capable of acting as diolefin ligands include hydrocarbons, such as COD (1,5-cyclooctadiene), NBD (norbornadiene), COT (cyclooctatetraene), and 1,5-hexadiene, in particular COD and NBD. These are preferably pure hydrocarbons; however, the presence of heteroatoms, for example also in the form of functional groups, is also possible.

X can denote bromide, chloride, iodide, or —O(CO)R2; it preferably denotes chloride or —O(CO)R2, in particular —O(CO)R2.

The non-aromatic monocarboxylic acid residues —O(CO)R1 and —O(CO)R2 in each case denote identical or different non-aromatic C6-C18 monocarboxylic acid residues, in each case with the exception of a phenylacetic acid residue. The term “non-aromatic” used in this context excludes purely aromatic monocarboxylic acid residues but not araliphatic monocarboxylic acid residues whose carboxyl function(s) is/are bound to aliphatic carbon. —O(CO)R1 and also —O(CO)R2 do not under any circumstances denote a phenylacetic acid residue. Preferably, —O(CO)R1 and —O(CO)R2 denote identical non-aromatic C6-C18 monocarboxylic acid residues, but preferably under no circumstances phenylacetic acid residues. Among the non-aromatic C6-C18 monocarboxylic acid residues, monocarboxylic acid residues having 8 to 18 carbon atoms, i.e., non-aromatic C8-C18 monocarboxylic acid residues, are preferred.

Examples of non-aromatic C6-C18 or the preferred C8-C18 monocarboxylic acids having the residues —O(CO)R1 or —O(CO)R2 include hexanoic acids, heptanoic acids, octanoic acids, nonanoic acids, and decanoic acids, to name but a few examples. Not only linear representatives but also those having branches and/or cyclic structures, such as 2-ethylhexanoic acid, cyclohexanecarboxylic acid, and neodecanoic acid, are included. The respective residues R1 and R2 bonded to a carboxyl group comprise 5 to 17 or even preferably 7 to 17 carbon atoms; benzyl is thereby excluded.

Preferred examples of palladium complexes according to the invention include [(COD)Pd[O(CO)R1]₂]ₙ and [(NBD)Pd[O(CO)R1]₂]ₙ, wherein n is 1 or 2 and in particular 1, and wherein R1 represents a non-aromatic C5-C17 hydrocarbon residue with the exception of benzyl.

Preferred examples of rhodium complexes according to the invention include [(COD)Rh[O(CO)R1]]ₘ and [(NBD)Rh[O(CO)R1]]ₘ, wherein m is 2, and wherein R1 represents a non-aromatic C5-C17 hydrocarbon residue, with the exception of benzyl.

Preferred examples of iridium complexes according to the invention include [(COD)Ir[O(CO)R1]]ₘ and [(NBD)Ir[O(CO)R1]]ₘ, wherein m is 2, and wherein R1 represents a non-aromatic C5-C17 hydrocarbon residue, with the exception of benzyl.

The noble metal complexes according to the invention can be easily produced by ligand exchange, in particular without using carboxylic acid silver salts in the process. The production method includes mixing and suspending or emulsifying a two-phase system. One phase here comprises a reactant of the type LPdX₂ or [LRhX]₂ or [LIrX]₂, in each case with X selected from bromide, chloride, and iodide, preferably chloride, either as is or preferably in the form of an at least substantially water-immiscible organic solution of such a reactant. Examples of organic solvents that are suitable for producing such an organic solution and at least substantially water-immiscible also include oxygen-containing solvents, for example corresponding water-immiscible ketones, esters, and ethers, in addition to aromatics and chlorinated hydrocarbons, such as toluene, xylene, di-, tri-, and tetrachloromethane. In contrast, the other phase comprises, for example, an aqueous solution of alkali metal salt (in particular sodium or potassium salt) and/or magnesium salt of a C6-C18 monocarboxylic acid of the type R1COOH and optionally additionally of the type R2COOH. The selection of the type of monocarboxylic acid salt(s) depends on the type of noble metal complex according to the invention which is to be produced or the combination of noble metal complexes according to the invention which is to be produced. The two phases are intensively mixed, for example by shaking and/or stirring, thereby forming a suspension or an emulsion. Mixing is performed for the purpose of maintaining the suspension or emulsion state, for example for a duration of 0.5 to 24 hours, for example at a temperature in a range from 20 to 50° C. The ligand exchange takes place in the process, the noble metal complex or complexes according to the invention formed dissolving in the organic phase, while the alkali metal X salt or MgX₂ salt that is likewise formed dissolves in the aqueous phase. Upon completion of the suspension or emulsification, organic and aqueous phase are separated from one another. The noble metal complex or complexes according to the invention formed can be obtained from the organic phase and, optionally, subsequently purified by means of conventional methods.

For example, to name but one specific example, (COD)Pd[O(CO)CH(C₂H₅)C₄H₉]₂ can be produced by jointly emulsifying a solution of (COD)PdCl₂ in dichloromethane with an aqueous solution of sodium 2-ethylhexanoate. After completion of emulsification, the saline solution that is thereby formed by ligand exchange can be separated from the dichloromethane phase, and the (COD)Pd[O(CO)CH(C₂H₅)C₄H₉]₂ can be isolated from the latter and optionally purified via conventional purification methods. For example, the palladium complex (COD)Pd[O(CO)CH(C₂H₅)C₄H₉]Cl can also be produced analogously if the stoichiometry is selected accordingly.

The noble metal complexes according to the invention are readily soluble to infinitely soluble in conventional organic solvents. For example, they can be dissolved in aliphates, cycloaliphates, aromatics such as toluene or xylene, alcohols, ethers, glycol ethers, esters, and ketones to form real solutions, i.e., non-colloidal solutions.

An important property in addition to said solubility in conventional organic solvents is the comparatively low decomposition temperature of the noble metal complexes according to the invention, for example from as low as 150° C. to generally no higher than 200° C. This combination of properties makes it possible to use the noble metal complexes according to the invention for producing layers comprising noble metal on substrates. It is also advantageous, in particular in the production of palladium layers by means of the embodiment of palladium complexes according to the invention, that no preparations containing colloidal palladium or nanopalladium need to be used, and therefore any risks associated therewith can be avoided.

For the purpose of generating a layer comprising noble metal, the organically dissolved noble metal complexes according to the invention can be applied to a substrate, for example directly as an organic solution, or the organic solution can be a component of a preparation comprising at least one further component. A coating comprising a noble metal complex according to the invention or noble metal complexes according to the invention can first be dried and freed of organic solvent before it or the dried residue is subjected to decomposition by thermal treatment to form a layer comprising noble metal. When working with the embodiment of palladium complexes according to the invention, palladium metal is formed as a layer during the thermal decomposition even in the presence of air as ambient atmosphere; in contrast, however, during the thermal decomposition in the embodiment of rhodium or iridium complexes according to the invention, no noble metal layers are formed in the presence of air as ambient atmosphere, but rather the corresponding noble metal oxide layers are formed. In this regard, the person skilled in the art understands the expression “layer comprising noble metal” used herein to be a layer comprising palladium or consisting of palladium, a layer comprising rhodium oxide or consisting of rhodium oxide, or a layer comprising iridium oxide or consisting of iridium oxide. The thermal treatment comprises heating to an object temperature above the decomposition temperature of a noble metal complex according to the invention or a combination of noble metal complexes according to the invention. For this purpose, for example, heating is generally performed briefly to an object temperature above the aforementioned decomposition temperature range of 150° C. to 200° C., i.e., for example, correspondingly to >150° C. to >200° C., for example to 250° C. or even to 1000° C., for example in a furnace and/or by infrared irradiation. In general, an object temperature is selected to be slightly above the decomposition temperature. In general, the heating, more precisely stated the maintenance of the object temperature, does not require longer than 15 minutes.

Palladium layers obtainable in this way are characterized by high metallic luster comparable to a mirror, and the palladium layers are homogeneous in terms of a smooth, non-granular outer surface.

The thickness of the layers comprising noble metal may, for example, be in the range from 50 nm to 5 μm, and the layers comprising noble metal may have a planar nature with or without desired discontinuities within the surface, or may comprise a desired pattern or design. The layers comprising noble metal may even be produced on temperature-sensitive substrates, i.e., for example, on substrates that are not temperature-stable above 200° C. For example, these may be temperature-sensitive polymer substrates, for example those based on polyolefin or polyester.

### EXAMPLES

### Example 1, Production of (COD)Pd[O(CO)CH(C₂H₅)C₄H₉]₂ and Use Thereof for Production of a Palladium Layer

A solution of 35 mmol (COD)PdCl₂ in 200 ml dichloromethane was stirred, and a solution of 140 mmol sodium 2-ethylhexanoate in 150 ml water was added. The two-phase mixture was emulsified for 24 h at 20° C. by vigorous stirring. The dichloromethane phase turned yellow in the process.

The dichloromethane phase was separated, and the solvent was distilled off. The viscous, yellow residue was absorbed into petroleum benzine (40-60), and the solution was dried with magnesium sulfate and filtered. The petroleum benzine was then completely distilled off. A viscous yellow residue of (COD)Pd[O(CO)CH(C₂H₅)C₄H₉]₂ remained.

After 10 minutes of heating to 200° C., a specular, 0.5 μm thin layer of palladium could be obtained from a 20 μm thick layer of the (COD)Pd[O(CO)CH(C₂H₅)C₄H₉]₂.

### Example 2, Production of (NBD)Pd[O(CO)CH(C₂H₅)C₄H₉]₂

Analogously to example 1, 35 mmol (NBD)PdCl₂ in 200 ml dichloromethane were reacted with 140 mmol sodium 2-ethylhexanoate in 150 ml water.

### Example 3, Production of [(COD)Rh[O(CO)CH(C₂H₅)C₄H₉]]ₘ

Analogously to example 1, 16.3 mmol [(COD)RhCl]₂ in 200 ml dichloromethane were reacted with 65.3 mmol sodium 2-ethylhexanoate in 100 ml water.

### Example 4, Production of [(COD)Ir[O(CO)CH(C₂H₅)C₄H₉]]ₘ

Analogously to example 1, 16.3 mmol [(COD)IrCl]₂ in 200 ml dichloromethane were reacted with 65.3 mmol sodium 2-ethylhexanoate in 100 ml water.

### Example 5, Production of (COD)Pd[O(CO)(CH₂)₅C(CH₃)₃]₂

Analogously to example 1, 35 mmol (COD)PdCl₂ in 200 ml dichloromethane were reacted with 140 mmol sodium neodecanoate in 150 ml water.

### Example 6, Production of [(NBD)Rh[O(CO)CH(C₂H₅)C₄H₉]]ₘ

Analogously to example 1, 16.3 mmol [(NBD)RhCl]₂ in 200 ml dichloromethane were reacted with 65.3 mmol sodium 2-ethylhexanoate in 100 ml water.

1. A noble metal complex having diolefin and C6-C18 monocarboxylate ligands of the type [LPd[O(CO)R1]X]ₙ, [LRh[O(CO)R1]]ₘ or [LIr[O(CO)R1]]ₘ, wherein L denotes a compound acting as a diolefin ligand, wherein X is selected from bromide, chloride, iodide and —O(CO)R2, wherein —O(CO)R1 and —O(CO)R2 denote identical or different non-aromatic C6-C18 monocarboxylic acid residues, in each case with the exception of a phenylacetic acid residue, and wherein n is an integer ≥1 and m is an integer ≥2.

2. The noble metal complex according to claim 1, wherein integer n>1, and integer m is in the range from 2 to 5.

3. The noble metal complex according to claim 1, in individualized or combined form.

4. A noble metal complex of the type [(COD)Pd[O(CO)R1]₂]ₙ, [(NBD)Pd[O(CO)R1]₂]ₙ, [(COD)Rh[O(CO)R1]]ₘ, [(NBD)Rh[O(CO)R1]]ₘ, [(COD)Ir[O(CO)R1]]ₘ or [(NBD)Ir[O(CO)R1]]ₘ, wherein n is 1 or 2, wherein m is 2, and wherein R1 represents a non-aromatic C5-C17 hydrocarbon residue, with the exception of benzyl.

5. A method for producing noble metal complexes according to claim 1 via ligand exchange, comprising mixing of a two-phase system, wherein one phase comprises a reactant of the type LPdX₂, [LRhX]₂ or [LIrX]₂, either as is or as an at least substantially water-immiscible organic solution, with X selected from bromide, chloride, and iodide, and wherein the other phase comprises an aqueous solution of alkali metal and/or magnesium salt of monocarboxylic acids correspondingly selected from R1COOH and optionally R2COOH.

6. A use of one or more noble metal complexes according to claim 1, for producing a layer comprising noble metal on a substrate.

7. The use according to claim 6, wherein the substrate is a temperature-sensitive substrate.

8. The use according to claim 6, comprising the provision of an organic solution of the noble metal complex or complexes, application of the organic solution to a substrate directly or as a component of a preparation comprising at least one further component, and heating of the applied coating to an object temperature above the decomposition temperature of the noble metal complex or complexes.

9. The use according to claim 6, wherein the layer comprising noble metal is a layer comprising palladium metal, rhodium oxide or iridium oxide or consisting thereof.

10. A use of one or more noble metal complexes obtainable by a method according to claim 5, for producing a layer comprising noble metal on a substrate.
